(19) United States
(12) Patent Application Publication
(10) Pub. No.: US 2026/0099728 A1
(43) Pub. Date: Apr. 9, 2026

(54) TASK AGNOSTIC EMBEDDING BASED LABELING ESCALATION ON FLY

(71) Applicant: Microsoft Technology Licensing, LLC, Redmond, WA (US)

(72) Inventors: MohammadReza GHAEINI, Seattle, WA (US); Muhaimenul ADNAN, Issaquah, WA (US)

(21) Appl. No.: 18/907,811

(22) Filed: Oct. 7, 2024

(51) Int. Cl. G06N 5/01

(52) U.S. Cl. CPC G06N 5/01

(57) ABSTRACT

Aspects of the disclosure include machine learning architectures with task agnostic embedding-based labeling escalation on fly. A method includes receiving a request corresponding to a task and generating, by a first pass system, a first decision. The first pass system includes a first pass model having a first complexity. The method includes generating, for the task, a task embedding in an embedding space, determining, in the embedding space, a top K subspace having K embeddings having K closest distances to the task embedding, and determining embedding labels for the K embeddings. The method includes determining to escalate the task to a second pass system having a second pass model having a second, higher complexity and, responsive to determining the embedding labels, generating, by the second pass system, a second decision for the task and returning, responsive to receiving the request, a response including the second decision.

### INTRODUCTION

The subject disclosure relates to machine learning and artificial intelligence, and specifically to a machine learning architecture with task agnostic embedding-based labeling escalation on fly.

### A BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram for an embedding-based labeling escalation system in accordance with one or more embodiments;

FIG. 2 depicts an example process for embedding-based labeling escalation on fly in accordance with one or more embodiments;

FIG. 3 depicts an example labeled embedding space for embedding-based labeling escalation on fly in accordance with one or more embodiments;

FIG. 4 depicts an example transformer-based architecture for embedding-based labeling escalation on fly in accordance with one or more embodiments;

FIG. 5 depicts a block diagram of a computer system in accordance with one or more embodiments; and

FIG. 6 depicts a flowchart of a method in accordance with one or more embodiments.

The diagrams depicted herein are illustrative. There can be many variations to the diagrams or the operations described therein without departing from the spirit of this disclosure. For instance, the actions can be performed in a differing order or actions can be added, deleted or modified.

### DETAILED DESCRIPTION

### Overview

Machine learning (ML) and artificial intelligence (AI) systems face continual challenges related to errors and inaccuracies, which can affect their reliability and the overall user experience. In short, some degree of error and inaccuracies are inevitable within any such system, and a goal of any ML architecture is to minimize these errors and to reduce the recurrence of learned error types (e.g., similar errors). Unfortunately, minimizing errors and reducing error recurrence can be somewhat challenging, especially in the context of content ecosystems and other dynamic environments. These ecosystems are continuously influenced by global events, evolving user behaviors, and emerging content trends, which can rapidly change the landscape in which a machine learning model operates. In other words, the dynamic nature of some tasks makes it difficult to preemptively address all potential error types, as the model(s) may encounter scenarios that were not present in the training data. As a result, classifiers and other underlying ML systems must constantly adapt to new patterns and anomalies to maintain their accuracy and reliability. Additionally, the slow and resource-intensive process of retraining and updating classifiers and other model types further exacerbates the challenge, leaving such systems vulnerable to repeated mistakes that reduce their overall effectiveness in real-time applications.

Existing methods for error detection and correction include reactive pipelines and internal reports. Reactive pipelines allow for the immediate reporting and logging of errors as they occur, while internal reports provide a structured way to document and analyze these errors over time. While reactive pipelines and internal reports help identify some mistake vectors, addressing the root causes of all possible error types remains a complex and time-consuming process. In particular, the complexity and diversity of errors that can arise in dynamic ecosystems such as content moderation make it challenging to develop a one-size-fits-all solution. There is a need for a more efficient, task-agnostic approach to mitigate production mistakes in real-time (that is, “on fly”), ensuring that once an error is detected, similar mistakes are avoided in the future, regardless of the underlying environment and/or ecosystem.

This disclosure introduces a machine learning architecture with task agnostic embedding-based labeling escalation on fly. The proposed system is designed to address the limitations of traditional error detection and correction methods by providing a real-time, adaptive approach to mitigating production mistakes. One of the core ideas of embedding-based labeling escalation on fly is to label the embeddings of prior tasks according to whether the underlying ML system handling the respective task did so correctly or incorrectly. That way, when a new task is received (e.g., a content moderation decision request, etc.) that requires a label (e.g., should this content be allowed or excluded, etc.), a K-nearest neighbors (KNN) search can be made over the embeddings to determine a probability of the new task being correctly or incorrectly handled by the underlying system (e.g., whether a content moderation decision will be right or wrong).

When the KNN search indicates that the underlying system is likely to be deficient for the task (as measured against any predetermined accuracy threshold, as desired), the proposed system escalates the task (e.g., content for a content moderation decision) to a relatively more complex and/or sophisticated second pass system for verification. In an example, this process is referred to as embedding-based labeling escalation on fly. While not meant to be particularly limited, the second pass system can include a relatively more advanced machine learning model than the initial ML system (the “first pass” system), such as, for example, a model having more layers, more parameters, and/or more inference compute resources. In other words, the second pass system can be thought of as a relatively more reliable labeling source. Advantageously, the output from the second pass system can be compared against the output from the first pass system (the original decision) and the results of that comparison can be used to update the task embedding space. In other words, a known label (e.g., correct or incorrect) can be added to the respective embedding for the task depending on whether the second pass system agreed with (correct) or disagreed with (incorrect) the first pass system.

Conversely, when the KNN search shows that the first pass system is likely to handle the task correctly (again, according to any desired predetermined threshold accuracy), the machine learning architecture described herein proceeds with the original decision made by the underlying ML model without invoking the second pass model. This approach ensures that the overall system architecture operates as efficiently as possible, only escalating tasks to the relatively more complex second pass system when there is a high probability of error, thereby optimizing resource usage and maintaining high levels of accuracy and reliability in real-time applications.

Notably, the system described herein is task agnostic in the sense that underlying embedding-based labeling escalation techniques can be applied across a wide variety of machine learning tasks without being tailored to any specific application or domain. More specifically, task flexibility is achieved in part because labeling escalation is based on a comparison of outcomes for different embeddings, meaning that the actual tasks which underpinned those embeddings have been abstracted away.

### Detailed Embodiment

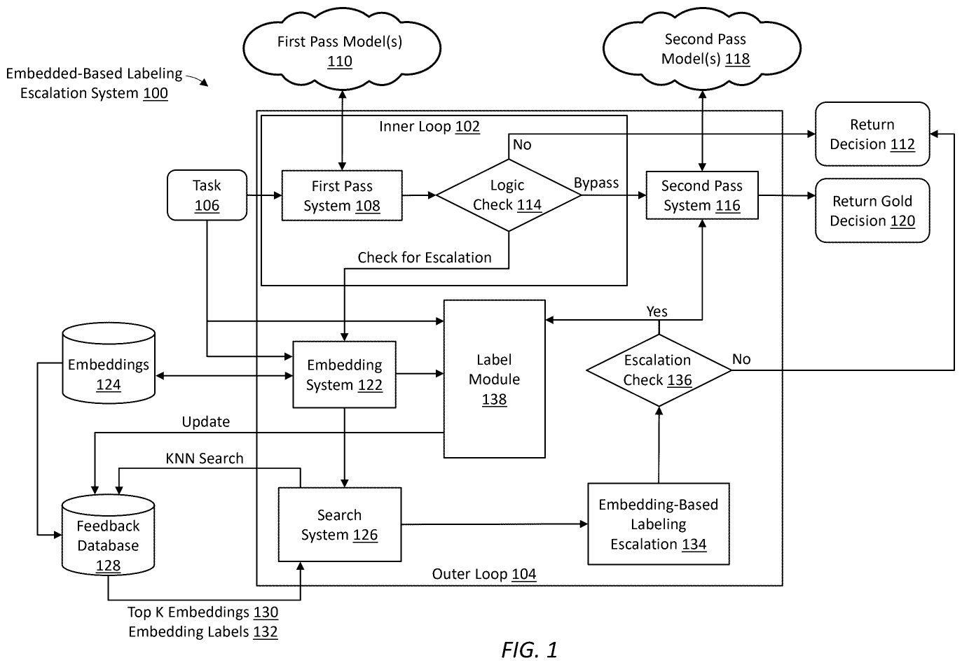

FIG. 1 depicts a block diagram for an embedding-based labeling escalation system 100 in accordance with one or more embodiments. As shown in FIG. 1, the embedding-based labeling escalation system 100 includes an inner loop 102 and an outer loop 104, configured and arranged as shown. Inner loop 102 and outer loop 104 work cooperatively to process task 106. Task 106 is not meant to be particularly limited, and can include any machine learning task, such as, for example, a classification task (e.g., a content moderation decision request, span detection, sentiment analysis, etc.), a regression task (e.g., message volume prediction, article retrieval rate prediction, etc.), a clustering task (e.g., user segmentation, document clustering, image segmentation, etc.), an anomaly detection task (e.g., fraud detection, equipment monitoring, etc.), a recommendation task (e.g., a connection recommendation in a connections network, etc.), a natural language processing task (e.g., machine translation task, etc.), a computer vision task (e.g., object detection, facial recognition, image generation, etc.), a reinforcement learning task (e.g., autonomous driving tasks, robotic tasking such as navigating, manipulating, etc.), etc. In short, task 106 can be any machine learning task that needs to be processed by the embedding-based labeling escalation system 100.

In some embodiments, task 106 is passed to or otherwise received by a first pass system 108 in the inner loop 102. The first pass system 108 processes task 106 using one or more first pass models 110, depending on characteristics of task 106, to generate a decision 112. In some embodiments, the first system 108 is designed to handle initial decision-making for task 106 (e.g., an initial classification of content). While not meant to be particularly limited, in some embodiments, first pass models 110 are relatively less complex models and/or relatively less resource-intensive models (as compared to second pass models 118 discussed in greater detail below) that are designed and/or trained to handle a range of tasks, such as classification or decision-making for content. In some embodiments, first pass system 108 calls one or more of the first pass models 110 depending on a type of the task 106. For example, if task 106 is a request for a recommendation in a connections network, first pass system 108 can call a recommendation model. In another example, if task 106 is to moderate content in a connections network, first pass system 108 can call a content moderation model. In yet another example, if task 106 is to detect spam messages in real-time, first pass system 108 can call a spam detection model.

The output of the first pass system 108 (that is, decision 112) is then subjected to a logic check 114. In some embodiments, logic check 114 is a rules-based classifier that determines whether the type or class of decision 112 should be checked for on-the-fly escalation. To illustrate, consider the context of a content moderation decision. In this scenario, logic check 114 might include a rule that any moderation actions taken against content need not be checked as, at worst, benign content might be inadvertently removed from the platform. Conversely, logic check 114 might include a rule that any moderation decision which allows a particular piece of content should be checked for escalation, as the platform might be less willing to accept inadvertently allowing harmful content to remain on the platform.

Continuing with this context, first pass system 108 might render a decision 112 that a particular piece of content should be removed from the underlying platform and thus, logic check 114 can indicate that an escalation check is not needed (as shown, “No” in FIG. 1). In this case, the embedding-based labeling escalation system 100 can return decision 112 in response to receiving task 106. On the other hand, first pass system 108 might render a decision 112 that a particular piece of content is allowed and thus, logic check 114 can indicate that an escalation check is needed (as shown, “Check for Escalation” in FIG. 1). In this case, inner loop 102 can initiate an escalation check to the outer loop 104 (described in greater detail below). In some embodiments, logic check 114 can be configured to classify one or more predetermined task types and/or contexts for immediate review by the second pass system 116 (as shown, “Bypass” in FIG. 1). This scenario might be appropriate, for example, when the content is provided to an account of someone under the age of 18 (and thus, the platform is even less willing to allow content to remain without checking for escalation). In this case, task 106 can be passed directly to second pass system 116 without checking for escalation, thus saving the compute and time associated with escalation checking.

In any case, an escalation check initiated by the inner loop 102 (refer above) can be passed to an embedding system 122 of the outer loop 104. In some embodiments, embedding system 122 fetches and/or otherwise receives the task 106 responsive to receiving the call to check for escalation. In some embodiments, embedding system 122 is configured to generate and/or to retrieve one or more embeddings 124 for task 106. While not meant to be particularly limited, embeddings 124 can be dense, high-dimensional vector representations of the task 106. Embeddings 124 capture the relationships and interactions between different features of the task 106, providing a rich and compact representation that can be used for various downstream operations.

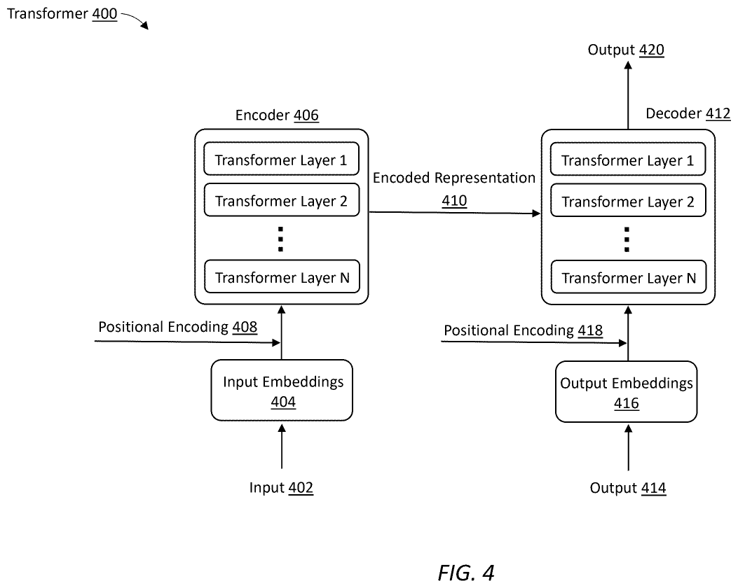

In some embodiments, the embedding system 122 processes task 106 (e.g., input data, such as user activities, text, images, or other forms of content), and transforms them into numerical vectors that encapsulate essential characteristics and context of the respective input. For example, in a content moderation scenario, the embedding system 122 might convert a user comment into an embedding that captures the sentiment, tone, and key topics of the comment. In a recommendation system, the embedding system 122 could generate embeddings for user interactions and items, allowing the system to identify similar users and recommend relevant content. In some embodiments, embedding system 122 includes or leverages a neural network(s) and/or other machine learning model(s) (e.g., large language model encoders and/or decoders, etc.) to learn to generate embeddings from input features. Encoders, decoders, and the generation of embeddings are discussed in greater detail with respect to FIG. 4. The underlying process for generating the embeddings 124 is not meant to be particularly limited and can include, for example, ada-embedding and bag-of-words (BOW) embedding, as desired.

In some embodiments, the embeddings 124 generated or retrieved by the embedding system 122 are passed to a search system 126. In some embodiments, search system 126 uses the embeddings 124 to perform a K-nearest neighbors (KNN) search over a feedback database 128. The KNN search is not meant to be particularly limited, but can include, for example, a hierarchical navigable small world (HNSW) search. HNSW is an algorithm used for efficient nearest neighbor search in high-dimensional spaces and is particularly well-suited for retrieving similar examples stored in a KNN database (e.g., feedback database 128). HNSW builds a graph-based structure that allows for fast and accurate retrieval of the most similar items to a given query.

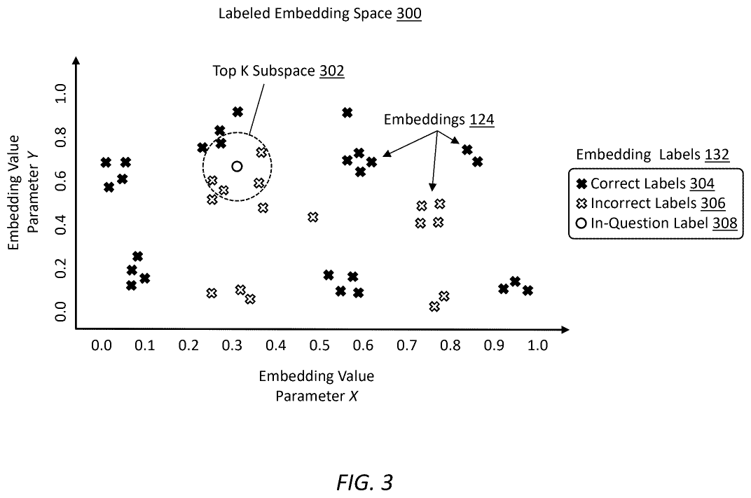

In some embodiments, search system 126 retrieves, during the KNN search, top K embeddings 130 of K prior tasks that have embeddings that are the K^{th} most similar to the embeddings 124 of the task 106 (according to any desired distance measure in an embedding space in which the respective embeddings reside). In some embodiments, search system 126 also retrieves embedding labels 132 for the top K embeddings 130. Embedding label 132 defines whether the prior task decision (e.g., return decision 112) of the respective top K embedding 130 was decided “correctly” or “incorrectly” by the first pass system 108. The labeling of embeddings is discussed in greater detail with respect to FIG. 3.

In some embodiments, embedding labels 132 can include additional embedding labels (not separately indicated). These additional labels can define additional contextual data, such as, in the context of content moderation, labels for “manual take downs” (that is, labels that identify prior task decisions which were manually overridden to identify, for example, areas that the first pass system 108 may cause a leakage), regions with false negatives (e.g., areas that the first pass system 108 handled correctly, but which triggered an escalation check which was found to be unnecessary and/or which triggered second pass system 116, which agreed with first pass system 108), etc.

In some embodiments, the top K embeddings 130 and embedding labels 132 are passed to embedding-based labeling escalation 134. In some embodiments, embedding-based labeling escalation 134 performs an escalation check 136 based on the results of the KNN search (that is, using the top K embeddings 130 and embedding labels 132). In some embodiments, escalation check 136 evaluates a top K subspace 302 in a labeled embedding space 300 (refer to FIG. 3) to decide if task 106 should be escalated to the second pass system 116. The top K subspace 302 defines the KNN region around the embedding in question (that is, the embedding 124 of task 106). In other words, the top K subspace 302 is the region around the embedding 124 of task 106 which contains K neighbors. If the check indicates a high likelihood of error (as measured against any predetermined threshold, as desired), the task 106 is escalated to the second pass system 116; otherwise, embedding-based labeling escalation system 100 proceeds with the initial decision and returns decision 112.

In some embodiments, the threshold for determining whether escalation is required is set according to one or more rules-based action strategies. Action strategies may vary depending on the characteristics, criticality, and/or scope of the task 106 and are not meant to be particularly limited. In some embodiments, action strategies define one or more rules for evaluating the top K subspace 302. In some embodiments, a first rule can state that, if a majority (simple, major, etc.) of the embedding labels 132 within the top K subspace 302 are “incorrect” labels, escalate. In some embodiments, a second rule can state that, if a most similar example (that is, an example embedding having a closest distance to the embedding of interest) has an “incorrect” label, escalate. In some embodiments, a third rule can state that, if at least one example has a label indicating a manual override (e.g., a manual take down of content, a manual reinstatement of content, etc.), escalate. Other rules are possible and are within the contemplated scope of this disclosure.

Turning now to the second pass system 116 specifically, escalation can be triggered via a “check for escalation” and or via a “bypass” as described previously. In any case, when escalation is called, second pass system 116 uses one or more second pass models 118, depending on characteristics of task 106, to generate a gold decision 120. While not meant to be particularly limited, in some embodiments, second pass models 118 are relatively more complex models and/or relatively more resource-intensive models (as compared to first pass models 110 discussed previously) that are designed and/or trained to handle a range of tasks, such as classification or decision-making for content. In some embodiments, second pass system 116 calls one or more of the second pass models 118 depending on a type of the task 106, in a similar manner as discussed previously with respect to first pass system 108. For example, if task 106 is a request for a recommendation in a connections network, second pass system 116 can call a recommendation model. The output of the second pass system 116 (that is, gold decision 120) can then be returned as a response to receiving task 106.

In some embodiments, second pass models 118 can include one or more model(s) having more layers, more parameters, and/or more inference compute resources than the first pass models 110. The relative differences in complexity between the second pass models 118 and the first pass models 110 is not meant to be particularly limited, except that second pass models 118 will be relatively more capable than first pass models 110. For example, first pass model 110 might include a transformer model having 3 hidden layers and 25 parameters, while second pass model 116 might include a transformer model having 70 hidden layers and thousands of parameters. In another example, first pass model 110 might include a rules-based lookup table, while second pass model 116 might include a transformer model having 10 hidden layers and 30 parameters. All such combinations are possible and within the contemplated scope of this disclosure.

To illustrate the roles of the first pass model 110 and the second pass model 118, consider a content moderation system designed to detect and filter out inappropriate comments on a social media platform. In this scenario, the first pass model 110 might include a basic content moderation model that performs an initial, relatively fast screening of user comments. This model is designed to quickly process a large volume of comments and to flag potentially inappropriate content (sometimes for further review). The model might use a combination of keyword matching and simple machine learning techniques to identify comments that may contain offensive language, hate speech, or other violations of platform policies, for example, to identify predetermined hate speech in content. The second pass model 118, on the other hand, might be a sophisticated transformer-based architecture having an encoder and/or decoder that has been trained to understand the context and semantics of human language (e.g., a comment in its presented context). The second pass model 118 can therefore detect subtler forms of inappropriate content, such as sarcasm, context-dependent insults, and nuanced hate speech, that the first pass model 110 might miss.

In some embodiments, escalation to the second pass system 116 triggers a label module 138 to update the feedback database 128. This update process involves comparing, by the label module 138 and/or outer loop 104, the gold decision 120 output from the second pass system 116 to the decision 112 originally provided by the first pass system 108. In some embodiments, and the results of that comparison can be used to update the feedback database 128. In some embodiments, the respective embedding 124 for task 106 can be coupled to an embedding label 132 denoting whether the output from the second pass system 116 agreed with the output from the first pass system 108. For example, if the output from the second pass system 116 disagreed with the output from the first pass system 108, the embedding 124 for task 106 can be coupled to the embedding label 132 for “incorrect” decisions (refer to FIG. 3). In this manner, the embedding-based labeling escalation system 100 will naturally build up a repository of embeddings and their associated labels, which can then be used for later tasks 106. Thus, embedding-based labeling escalation system 100 will, over time, become better able to estimate escalation requirements for an ever-broader range of tasks. In other words, embedding-based labeling escalation system 100 is an adaptive, task-agnostic system that supports task agnostic embedding-based labeling escalation on fly.

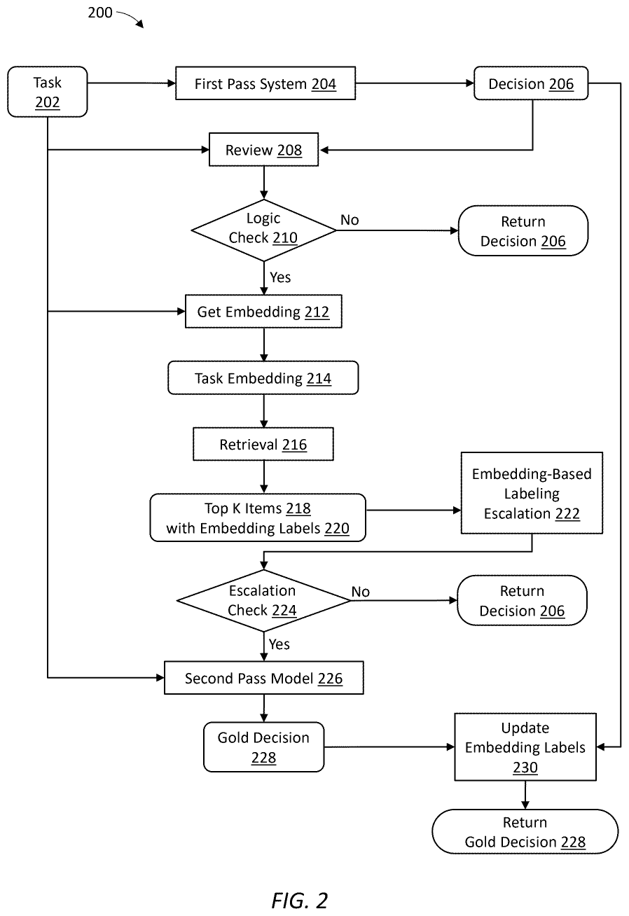

FIG. 2 depicts an example process 200 for embedding-based labeling escalation on fly in accordance with one or more embodiments. As shown in FIG. 2, process 200 begins with the receiving of task 202. Task 202 can be provided manually or via one or more upstream systems (not separately indicated). Task 202 is passed to a first pass system 204, which generates a decision 206. Task 202 and decision 206 are then passed to review 208 (refer to logic check 114 of FIG. 1). If an escalation check is not required, the decision 206 is returned responsive to receiving task 202. If an escalation check is required, process 200 proceeds to an embedding fetch process (as shown, “get embedding 212”).

Get embedding 212 involves generating and/or fetching a task embedding 214. Task embedding 214 can be generated via an encoder, decoder, or other machine learning system as desired (refer to embedding system 122 of FIG. 1). In addition, or alternatively, task embedding 214 can be fetched from a database.

After generating and/or fetching task embedding 214, process 200 proceeds to retrieval 216. Retrieval 216 involves determining top K items 218 and associated embedding labels 220. In some embodiments, retrieval 216 includes a KNN search of a plurality of known embeddings (refer to search system 126 of FIG. 1). In some embodiments, the top K items 218 are the top K embeddings which are closest to the task embedding 214 in an embedding space according to a predetermined distance measure (cosine similarity, Euclidean distance, etc.). In some embodiments, the KNN search is a HNSW search, although other search techniques are possible, and all such configurations are within the contemplated scope of this disclosure.

The top K items 218 and associated embedding labels 220 are passed to embedding-based labeling escalation 222 for an escalation check 224 (refer to escalation check 136 of FIG. 1). If escalation is not required, the decision 206 is returned responsive to receiving task 202. If an escalation is required, task 202 is passed to second pass model 226 (also referred to as a labeling tier).

Second pass model 226 generates, from task 202, a gold decision 228. The gold decision 228 can be used to update stored labels (as shown “update embedding labels 230”, refer to label module 138 of FIG. 1). In some embodiments, a 2-tuple is generated from a concatenation of the task embedding 214 and the respective label (e.g., “correct”, “incorrect”, etc.). In some embodiments, a 3-tuple is generated from a concatenation of the task 202, task embedding 214, and the respective label (e.g., “correct”, “incorrect”, etc.). The N-tuples can be stored in an embedding database for later use (refer to embeddings 124 and feedback database 128 of FIG. 1). In any case, the gold decision 228 can be returned responsive to receiving task 202.

FIG. 3 depicts an example labeled embedding space 300 in accordance with one or more embodiments. As shown in FIG. 3, labeled embedding space 300 provides a representation of a number of embeddings 124. In some embodiments, embeddings 124 are embeddings for respective tasks 106 (refer to FIG. 1). More specifically, labeled embedding space 300 depicts a two-dimensional embedding space where each embedding 124 is positioned according to respective embedding values for a first parameter (parameter X) and a second parameter (parameter Y). It should be understood that the number and type of parameters shown is merely illustrative and was chosen only for convenience. In practice, the number of parameters for labeled embedding space 300 can be of the order of hundreds, thousands, tens of thousands, etc. and, accordingly, the labeled embedding space 300 can be an N-dimensional embedding space where N is arbitrarily high, as desired.

In some embodiments, each embedding 124 is assigned a vector value according to the respective embedding values for the first parameter and the second parameter (and fourth parameter, fifth parameter, etc.). In some embodiments, each embedding 124 is assigned a vector value that is a concatenation of the respective embedding values which make up the respective embedding. In this manner, the labeled embedding space 300 represents a high-dimensional space in which the relationships and interactions between different features of the underlying tasks 106 are captured.

As further shown in FIG. 3, in some embodiments, each embedding 124, in addition to being assigned a position and/or vector value with respect to labeled embedding space 300, is assigned an embedding label 132. In some embodiments, embedding labels 132 includes correct labels 304 for correct decisions made by a first pass system (e.g., first pass system 108 of FIG. 1) and incorrect labels 306 for incorrect decisions made by the first pass system. The embedding labels 132 are represented by closed stylized Xs (correct labels 304) and open stylized Xs (incorrect labels 306), although any designation(s) can be used and all such configurations are within the contemplated scope of this disclosure.

In some embodiments, a top K subspace 302 can be defined according to an embedding 124 of interest, that is, an embedding 124 which does not yet have a known embedding label 132 (as shown, an in-question label 308). As shown, K is set to 5 (observe that the radius of the top K subspace 302 is set such that 5 embeddings 124 remain, not counting the in-question label 308), but the value of K is not meant to be particularly limited. In some embodiments, K can be more or less than 5, for example, 2, 4, 10, 20, 50, etc., as desired.

In some embodiments, the embedding labels 132 of the embeddings 124 which lie within the top K subspace 302 can be used to support a rules-based action strategy (refer to escalation check 136 of FIG. 1). For example, an escalation decision can be made with respect to the in-question label 308 according to the relative and/or absolute number of correct labels 304 and/or incorrect labels 306 within the top K subspace 302.

Turning now to FIG. 4, in some embodiments, the embedding-based labeling escalation system 100, process 200, and/or labeled embedding space 300 can be implemented in whole or in part using a transformer-type architecture (e.g., transformer 400), such as those relied upon in some large language models (LLMs). For example, in some embodiments, first pass system 106, second pass system 116, embedding system 122, label module 138, search system 126, and/or embedding-based labeling escalation 134 are implemented in whole or in part using transformer-type encoders, decoders, and/or combinations thereof.

While not meant to be particularly limited, large language models are neural network machine learning architectures that are capable of processing large amounts of text data and generating high-quality natural language responses. In practice, large language models have been used for a wide range of natural language processing (NLP) tasks, including, for example, machine translation, text generation, sentiment analysis, and question answering (e.g., query-and-response). Large language models have also been adapted for other domains, such as computer vision, speech recognition, and software development.

At its core, a large language model consists of an encoder and a decoder. The encoder takes in a sequence of input tokens, such as words or characters, and produces a sequence of hidden representations for each token that capture the contextual information of the input sequence. The decoder then uses these hidden representations, along with a sequence of target tokens, to generate a sequence of output tokens.

The most popular and widely used types of large language models are recurrent neural networks (RNNs) and transformers. RNNs are neural networks that process sequences of inputs one by one, and use a hidden state to remember previous inputs. RNNs are particularly well-suited for tasks that involve sequential data, such as text, audio, and time-series data. In a transformer, on the other hand, the encoder and decoder are composed of multiple layers of multi-headed self-attention and feedforward neural networks. The core of the transformer model is the self-attention mechanism, which allows the model to focus on different parts of an input sequence at different timesteps, without the need for recurrent connections that process the sequence one by one. Transformers leverage self-attention to compute representations of input sequences in a parallel and context-aware manner and are well-suited to tasks that require capturing long-range dependencies between words in a sentence, such as in language modeling and machine translation.

Large language models are typically trained on large amounts of text data, often containing hundreds of millions if not billions of words. To handle the large amount of data, the training process is often highly parallelized. The training process can take several days or even weeks, depending on the size of the model and the amount of training data involved. Large language models can be trained using backpropagation and gradient descent, with the objective of minimizing a loss function such as cross-entropy loss.

As shown in FIG. 4, transformer 400 begins with an input 402. The input 402 denotes an input provided by a user (or upstream system) and can be represented as a sequence of tokens, individual words or sub-words, from which input embeddings 404 can be generated. The input embeddings 404 represent the tokens within the input 402 as numbers, often vectors, which can be processed using encoder 406. In some embodiments, a positional encoding 408 can be generated to encode the position of each token in input 402 as a set of numbers. These numbers can be fed into the encoder 406 with the input embeddings 404 (using, e.g., concatenation), allowing the transformer-based architecture to more effectively understand the order of words in a sentence and to thereby generate grammatically correct and semantically meaningful outputs.

The encoder 406 processes the input embeddings 404 and the positional encoding 408 and generates, for the input 402, an encoded representation 410 (in this implementation, embeddings, such as the embeddings 124 and top K embeddings 130 of FIG. 1) that captures the meaning and context of the input 402.

To accomplish this, encoder 406 applies a series of self-attention transformer layers (or simply, “transformer layers”), which are a series of hidden states that represent the input 402 at different levels of abstraction. The encoder 406 can include any number of these transformer layers, as desired. In some embodiments, the encoded representation 410 is provided to a decoder 412.

The decoder 412 similarly includes a number of transformer layers, as desired, except that the decoder 412 processes an output 414. In most implementations, the output 414 is a right-shifted copy of the input 402, meaning that the decoder 412 can only use the previous words for next-word prediction. In some embodiments, output embeddings 416 can be generated from the output 414 to represent the tokens in the output 414 as numbers, in a similar manner as described with respect to the encoder 406. A positional encoding 418 can be added to the output embeddings 416 to encode the position of each token in output 414 as a set of numbers. The decoder 412 can be trained by minimizing a loss function (also known as an objective function, which quantifies a difference between a predicted output and a known true value) using, for example, gradient descent.

Once trained, transformer 400 can be used during an inference phase to generate an output 420, which, in the context of LLMs, can be thought of as a next-word probability (that is, how likely is the next word in the sequence to be x, or y, etc.). In some configurations, the transformer 400 includes a linear layer and SoftMax layer (omitted for clarity) to transform a raw output from the decoder 412 into the output 420. For example, after the decoder 412 produces a raw output (e.g., output embeddings), the linear layer can map the output embeddings to a higher-dimensional space, thereby transforming the output embeddings into a same original input space as the input 402. The SoftMax function can be used to generate a probability distribution for each output token in the vocabulary, enabling the transformer 400 to generate output tokens with probabilities (e.g., the output 420).

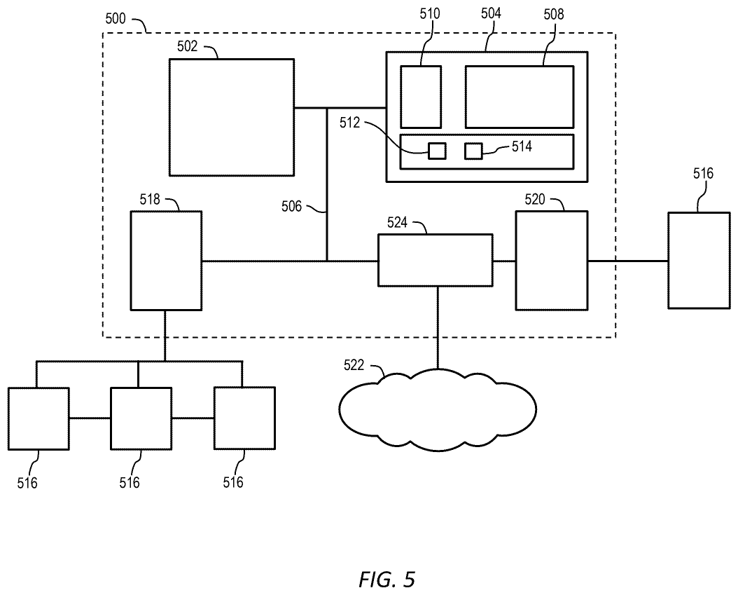

FIG. 5 illustrates aspects of an embodiment of a computer system 500 that can perform various aspects of embodiments described herein. In some embodiments, the computer system(s) 500 can implement and/or otherwise be incorporated within or in combination with the embedding-based labeling escalation system 100, process 200, labeled embedding space 300, and/or transformer 400 described previously (refer to FIGS. 1-4). In some embodiments, computer system 500 can be implemented server-side. For example, a remote computer system 500 can be configured to receive a task 106, and in response, to generate and return a decision 112 and/or gold decision 120 (depending, e.g., on whether escalation was required as described previously).

The computer system 500 includes at least one processing device 502, which generally includes one or more processors or processing units for performing a variety of functions, such as, for example, completing any portion of the embedding-based labeling escalation system 100 described previously. Components of the computer system 500 also include a system memory 504, and a bus 506 that couples various system components including the system memory 504 to the processing device 502. The system memory 504 may include a variety of computer system readable media. Such media can be any available media that is accessible by the processing device 502, and includes both volatile and non-volatile media, and removable and non-removable media. For example, the system memory 504 includes a non-volatile memory 508 such as a hard drive, and may also include a volatile memory 510, such as random access memory (RAM) and/or cache memory. The computer system 500 can further include other removable/non-removable, volatile/non-volatile computer system storage media.

The system memory 504 can include at least one program product having a set (e.g., at least one) of program modules that are configured to carry out functions of the embodiments described herein. For example, the system memory 504 stores various program modules that generally carry out the functions and/or methodologies of embodiments described herein. A module or modules 512, 514 may be included to perform functions related to any of the block diagrams described herein. The computer system 500 is not so limited, as other modules may be included depending on the desired functionality of the computer system 500. In an example, as used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 502 can also be configured to communicate with one or more external devices 516 such as, for example, a keyboard, a pointing device, and/or any devices (e.g., a network card, a modem, etc.) that enable the processing device 502 to communicate with one or more other computing devices. Communication with various devices can occur via Input/Output (I/O) interfaces 518 and 520.

The processing device 502 may also communicate with one or more networks 522 such as a local area network (LAN), a general wide area network (WAN), a bus network and/or a public network (e.g., the Internet) via a network adapter 524. In some embodiments, the network adapter 524 is or includes an optical network adaptor for communication over an optical network. It should be understood that although not shown, other hardware and/or software components may be used in conjunction with the computer system 500. Examples include, but are not limited to, microcode, device drivers, redundant processing units, external disk drive arrays, RAID systems, and data archival storage systems, etc.

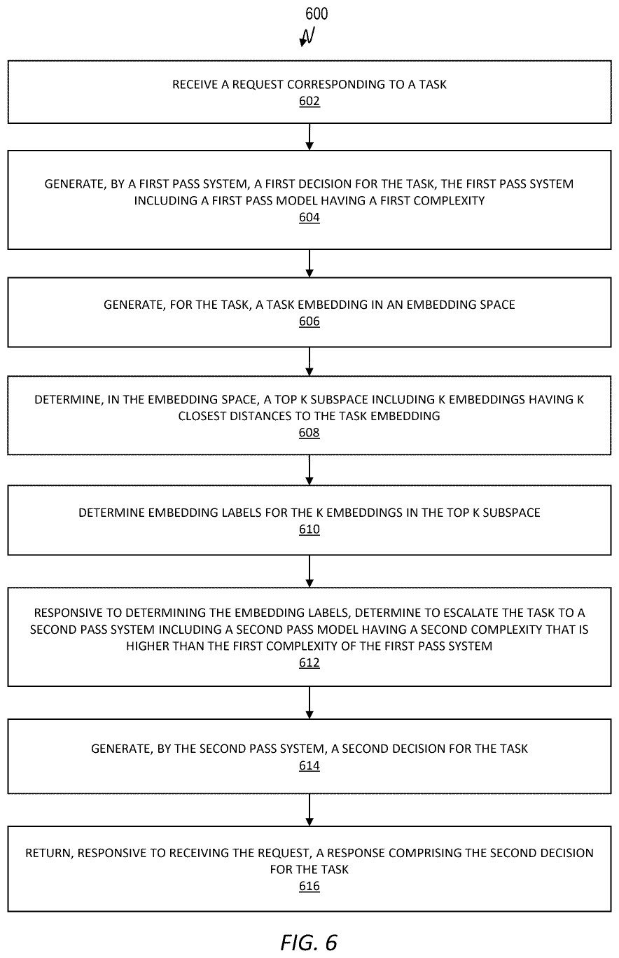

Referring now to FIG. 6, a flowchart 600 for embedding-based labeling escalation on fly is generally shown according to an embodiment. The flowchart 600 is described with reference to FIGS. 1 to 5 and may include additional steps not depicted in FIG. 6. Although depicted in a particular order, the blocks depicted in FIG. 6 can be, in some embodiments, rearranged, subdivided, and/or combined.

At block 602, the method includes receiving a request corresponding to a task.

At block 604, the method includes generating, by a first pass system, a first decision for the task. In some embodiments, the first pass system includes a first pass model having a first complexity.

At block 606, the method includes generating, for the task, a task embedding in an embedding space.

At block 608, the method includes determining, in the embedding space, a top K subspace having K embeddings having K closest distances to the task embedding.

At block 610, the method includes determining embedding labels for the K embeddings in the top K subspace.

At block 612, the method includes, responsive to determining the embedding labels, determining to escalate the task to a second pass system including a second pass model having a second complexity that is higher than the first complexity of the first pass system.

At block 614, the method includes, generating, by the second pass system, a second decision for the task.

At block 616, the method includes returning, responsive to receiving the request, a response including the second decision for the task.

In some embodiments, determining the embedding labels for the K embeddings includes assigning an embedding label to each embedding of the K embeddings according to a comparison of the first decision with the second decision for the respective task from which the respective embedding was generated. For example, an embedding can be assign a “correct label” or an “incorrect label” according to the comparison.

In some embodiments, the embedding labels include a first label (e.g., correct labels 304) when the first decision matches the second decision, and the embedding labels include a second label (e.g., incorrect labels 306) when the first decision disagrees with the second decision.

In some embodiments, determining whether to escalate the task to a second pass system further includes determining that a comparison of a number of first labels to a number of second labels in the top K subspace satisfies a predetermined threshold (refer, e.g., to the action strategies described previously).

In some embodiments, the method further includes determining an embedding label for the task embedding according to a comparison of the first decision to the second decision.

In some embodiments, the method further includes updating, after generating the second decision, the embedding space with the task embedding and the embedding label for the task embedding.

In some embodiments, the K embeddings are determined using a hierarchical navigable small world (HNSW) algorithm.

In some embodiments, a method includes receiving a request corresponding to a task and generating, by a first pass system, a first decision for the task. In some embodiments, the first pass system includes a first pass model having a first complexity.

In some embodiments, the method includes passing the first decision to a classifier configured to determine a class of the first decision and, responsive to the class, determining that the task should be checked for on-the-fly escalation to a second pass system including a second pass model having a second complexity that is higher than the first complexity of the first pass system.

In some embodiments, the method includes receiving, for the task, a task embedding in an embedding space, determining, in the embedding space, a top K subspace including K embeddings having K closest distances to the task embedding, and determining embedding labels for the K embeddings in the top K subspace.

In some embodiments, the method includes, responsive to determining the embedding labels, returning a response including the first decision for the task.

In some embodiments, a method includes receiving a request corresponding to a task and generating, by a first pass system, a first decision for the task. In some embodiments, the first pass system includes a first pass model having a first complexity.

In some embodiments, the method includes passing the first decision to a classifier configured to determine a class of the first decision.

In some embodiments, the method includes, responsive to the class, determining whether the task should be checked for on-the-fly escalation to a second pass system including a second pass model having a second complexity that is higher than the first complexity of the first pass system.

In some embodiments, the method includes determining, by the classifier, that the first decision belongs to a predetermined class and, responsive to determining the predetermined class, bypassing on-the-fly escalation and passing the task to the second pass system.

In some embodiments, the method includes generating, by the second pass system, a second decision for the task and returning, responsive to receiving the request, a response including the second decision for the task.

In some embodiments, the method includes generating, for the task, a task embedding in an embedding space and determining an embedding label for the task embedding according to a comparison of the first decision to the second decision.

In some embodiments, the method includes updating, after generating the second decision, the embedding space with the task embedding and the embedding label for the task embedding.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings.

According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

While the disclosure has been described with reference to various embodiments, it will be understood by those skilled in the art that changes may be made and equivalents may be substituted for elements thereof without departing from its scope. The various tasks and process steps described herein can be incorporated into a more comprehensive procedure or process having additional steps or functionality not described in detail herein. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

Unless defined otherwise, technical and scientific terms used herein have the same meaning as is commonly understood by one of skill in the art to which this disclosure belongs.

Various embodiments of the present disclosure are described herein with reference to the related drawings. The drawings depicted herein are illustrative. There can be many variations to the diagrams and/or the steps (or operations) described therein without departing from the spirit of the disclosure. For instance, the actions can be performed in a differing order or actions can be added, deleted or modified. All of these variations are considered a part of the present disclosure.

The terminology used herein is for the purpose of describing particular embodiments only and is not intended to be limiting. In an example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof. The term “or” means “and/or” unless clearly indicated otherwise by context.

The terms “received from”, “receiving from”, “passed to”, “passing to”, etc. describe a communication path between two elements and does not imply a direct connection between the elements with no intervening elements/connections therebetween unless specified. A respective communication path can be a direct or indirect communication path.

The corresponding structures, materials, acts, and equivalents of all means or step plus function elements in the claims below are intended to include any structure, material, or act for performing the function in combination with other claimed elements as specifically claimed.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Embodiments of the present disclosure may be implemented as or as part of a system, a method, and/or a computer program product at any possible technical detail level of integration. The computer program product may include a computer readable storage medium (or media) having computer readable program instructions thereon for causing a processor to carry out aspects of the present disclosure.

Various embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a special purpose computer to produce a machine, such that the instructions, which execute via the processor of the special purpose computer, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments described herein have been presented for purposes of illustration, but are not intended to be exhaustive or limited to the form(s) disclosed. The embodiments were chosen and described in order to best explain the principles of the disclosure. Many modifications and variations will be apparent to those of ordinary skill in the art without departing from the scope and spirit of the described embodiments. The terminology used herein was chosen to best explain the principles of the various embodiments, the practical application or technical improvement over technologies found in the marketplace, or to enable others of ordinary skill in the art to understand the embodiments described herein.

What is claimed is:

1. A method for task agnostic embedding-based labeling escalation on fly, the method comprising:
receiving a request corresponding to a task;
generating, by a first pass system, a first decision for the task, the first pass system comprising a first pass model having a first complexity;
generating, for the task, a task embedding in an embedding space;
determining, in the embedding space, a top K subspace comprising K embeddings having K closest distances to the task embedding;
determining embedding labels for the K embeddings in the top K subspace;
responsive to determining the embedding labels, determining to escalate the task to a second pass system comprising a second pass model having a second complexity that is higher than the first complexity of the first pass system;
generating, by the second pass system, a second decision for the task; and
returning, responsive to receiving the request, a response comprising the second decision for the task.

2. The method of claim 1, wherein determining the embedding labels for the K embeddings comprises assigning an embedding label to each embedding of the K embeddings according to a comparison of the first decision with the second decision for the respective task from which the respective embedding was generated.

3. The method of claim 2, wherein the embedding labels comprise a first label when the first decision matches the second decision, and wherein the embedding labels comprise a second label when the first decision disagrees with the second decision.

4. The method of claim 3, wherein determining to escalate the task to the second pass system further comprises a determining that a comparison of a number of first labels to a number of second labels in the top K subspace satisfies a predetermined threshold.

5. The method of claim 3, further comprising determining an embedding label for the task embedding according to a comparison of the first decision to the second decision.

6. The method of claim 5, further comprising updating, after generating the second decision, the embedding space with the task embedding and the embedding label for the task embedding.

7. The method of claim 1, wherein the K embeddings are determined using a hierarchical navigable small world (HNSW) algorithm.

8. The method of claim 1, wherein determining to escalate the task to the second pass system further comprises evaluating the embedding labels against one or more rules-based action strategies.

9. The method of claim 8, wherein, according to a rule of the one or more rules-based action strategies, determining to escalate the task to the second pass system further comprises determining that a majority of the embedding labels for the K embeddings in the top K subspace have a first label.

10. The method of claim 8, wherein, according to a rule of the one or more rules-based action strategies, determining to escalate the task to the second pass system further comprises determining that the respective embedding label for the embedding of the K embeddings having a closest distance to the task embedding has a first label.

11. The method of claim 8, wherein, according to a rule of the one or more rules-based action strategies, determining to escalate the task to the second pass system further comprises determining that at least one of the embedding labels for the K embeddings in the top K subspace have a first label.

12. A system comprising a memory, computer readable instructions, and one or more circuitry for executing the computer readable instructions, the computer readable instructions controlling the one or more circuitry to perform operations comprising:
receive a request corresponding to a task;
generate, by a first pass system, a first decision for the task, the first pass system comprising a first pass model having a first complexity;
passing the first decision to a classifier configured to determine a class of the first decision;
responsive to the class, determining that the task should be checked for on-the-fly escalation to a second pass system comprising a second pass model having a second complexity that is higher than the first complexity of the first pass system;
receiving, for the task, a task embedding in an embedding space;
determining, in the embedding space, a top K subspace comprising K embeddings having K closest distances to the task embedding;
determining embedding labels for the K embeddings in the top K subspace; and
responsive to determining the embedding labels, returning a response comprising the first decision for the task.

13. The system of claim 12, wherein determining the embedding labels for the K embeddings comprises assigning an embedding label to each embedding of the K embeddings according to a comparison of the first decision with the second decision for the respective task from which the respective embedding was generated.

14. The system of claim 13, wherein the embedding labels comprise a first label when the first decision matches the second decision, and wherein the embedding labels comprise a second label when the first decision disagrees with the second decision.

15. The system of claim 12, wherein determining to return the response comprising the first decision further comprises determining that on-the-fly escalation to the second pass system is not required.

16. The system of claim 15, wherein determining that on-the-fly escalation to the second pass system is not required comprises evaluating the embedding labels against one or more rules-based action strategies.

17. The system of claim 15, wherein determining that on-the-fly escalation to the second pass system is not required comprises determining that the embedding labels for the K embeddings in the top K subspace satisfy a predetermined condition.

18. A computer program product comprising a computer readable storage medium having program instructions embodied therewith, the program instructions executable by one or more processors to cause the one or more processors to perform operations comprising:
receive a request corresponding to a task;
generate, by a first pass system, a first decision for the task, the first pass system comprising a first pass model having a first complexity;
passing the first decision to a classifier configured to determine a class of the first decision;
responsive to the class, determining whether the task should be checked for on-the-fly escalation to a second pass system comprising a second pass model having a second complexity that is higher than the first complexity of the first pass system;
determining, by the classifier, that the first decision belongs to a predetermined class;
responsive to determining the predetermined class, bypassing on-the-fly escalation and passing the task to the second pass system;
generating, by the second pass system, a second decision for the task; and
returning, responsive to receiving the request, a response comprising the second decision for the task.

19. The computer program product of claim 18, further comprising:
generating, for the task, a task embedding in an embedding space; and
determining an embedding label for the task embedding according to a comparison of the first decision to the second decision.

20. The computer program product of claim 19, further comprising updating, after generating the second decision, the embedding space with the task embedding and the embedding label for the task embedding.
